(19) United States
(12) Patent Application Publication
(10) Pub. No.: US 2007/0178907 A1
(43) Pub. Date: Aug. 2, 2007

(54) System and method for locating mobile devices

(76) Inventors: Janakiraman Gopalan, Cupertino, CA (US); Varadachari Rengarajan, Cupertino, CA (US)

Correspondence Address: FAY KAPLUN & MARCIN, LLP, 15O BROADWAY, SUITE 702, NEW YORK, NY, 10038, US

(21) Appl. No.: 11/345,449

(22) Filed: Feb. 1, 2006

(51) Int. Cl. H04Q 7/20

(52) U.S. Cl. 455/456.1

(57) ABSTRACT

A system, device and method for receiving location information for one of a wireless infrastructure device (“WID”) and a mobile device, wherein the WID is a parent of the mobile device and the mobile device is a child of the WID. Data corresponding to the other one of the WID and the mobile device is retrieved and the data is updated to include the location information for the one of the WID and the mobile device when the data does not include a known location information for the other one of the WID and the mobile device.

### BACKGROUND INFORMATION

Mobile computing devices are becoming more powerful and expensive. A problem with such mobile devices is that, due to their portability (e.g., small, lightweight, etc.), they are easily transported but difficult to track. For example, large corporations may own hundreds or thousands of mobile devices that are scattered throughout their organization in various geographical locations. Within these locations, mobile devices are not always stored in a controlled, central location. As a result, devices are often misplaced, lost or even stolen by employees who are not associated with a specific device and thus not held responsible for the management of the devices that they operate or which they have contact.

Adding to the difficulty of mobile device management are problems such as hoarding of devices by individual groups within an organization. For example, departments within a retail store may hoard devices to ensure themselves the proper amount of resources to meet their needs. Organizations may also keep a large amount of spare devices to replace devices that may have been sent out for repair. Consequently, tracking and monitoring of mobile devices can become burdensome.

Conventional asset tracking systems are built around a central database designed to store information related to the identity and status of various devices. Updating of such a database requires manual operation of on-site appliances such as beacons, control computers and/or security monitor devices. For a large retail chain with a wide distribution of geographical locations, this kind of tracking is time consuming and consequently expensive. Minimization of costs is an important consideration in the modern business environment.

### SUMMARY OF THE INVENTION

A method for receiving location information for one of a wireless infrastructure device (“WID”) and a mobile device, wherein the WID is a parent of the mobile device and the mobile device is a child of the WID. Data corresponding to the other one of the WID and the mobile device is retrieved. The data is updated to include the location information for the one of the WID and the mobile device when the data does not include a known location information for the other one of the WID and the mobile device.

A method for storing information corresponding to an assigned site and a current site for a plurality of devices, wherein unknown is valid information for the assigned site and the current site. A triggering event is received for one of the devices. The assigned site and the current site for the one of the devices is propagated to at least one of the other devices.

A network management device having a storage means for storing information corresponding to an assigned site and a current site for a plurality of devices, wherein unknown is valid information for the assigned site and the current site. The device also including a receiving means for receiving a triggering event for one of the devices. The device further including a processing means for propagating the assigned site and the current site for the one of the devices to at least one of the other devices.

### BRIEF DESCRIPTION OF DRAWINGS

FIG. 1 shows an exemplary embodiment of a system on which the present invention may be implemented.

FIG. 2 provides an exemplary method for the propagation of wireless infrastructure device (“WID”) site names to its child mobile devices.

FIG. 3 provides an exemplary method for the propagation of mobile device site names to parent WID devices and sibling mobile devices.

### DETAILED DESCRIPTION

The present invention may be further understood with reference to the following description and the appended drawings, wherein like elements are referred to with the same reference numerals. The present invention provides a system and a method for efficiently tracking mobile devices and/or infrastructure devices that have moved from their desired locations/site to some other location/site. In particular, the exemplary embodiments of the present invention provides for determining the location of devices that are not capable of providing their location.

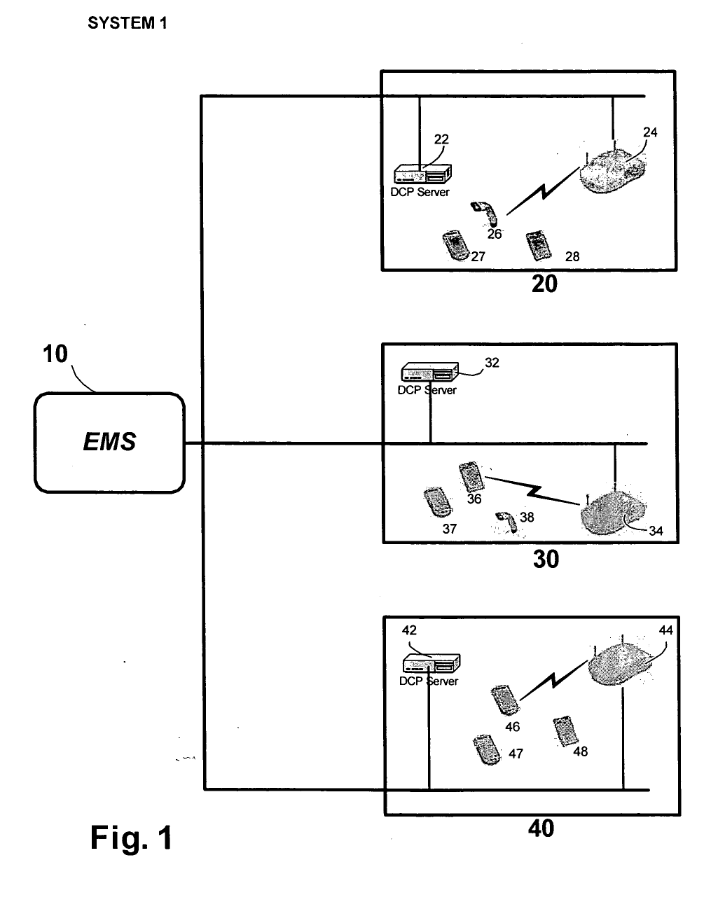

FIG. 1 illustrates an exemplary embodiment of a system 1 that may be used to implement the present invention. Those of skill in the art will understand that the system 1 is only exemplary and that the present invention may be implemented on systems and/or networks having different topologies. For example, in addition to the devices shown in FIG. 1, a typical network may also include additional devices such as network servers, network appliances, printers, network storage facilities, etc. that are either part of the wired and/or wireless portion of the network.

FIG. 1 shows a plurality of sites 20, 30 and 40. Exemplary sites 20, 30 and 40 may include, for example, a store, factory, distribution center, warehouse location, etc. In an alternative embodiment, sites 20, 30, 40 may be, for example, areas and/or departments within a store, factory, distribution center, warehouse location, etc. Thus, in the alternative embodiment a plurality of sites 20, 30, 40 may exist within a single location.

Throughout this description, the terms “site” and “location” may be used interchangeably to describe a logical grouping of mobile devices and/or infrastructure devices. In an exemplary embodiment, a site would include an FTP server and the mobile devices configured to communicate with that FTP server. The various sites within a system or network may be defined by, for example, the owner of the network, the operator of the network, the supplier of the network and/or devices, etc.

Each of the sites 20, 30 and 40 utilize one or more mobile devices, e.g., mobile device 26-28, 36-38 and 46-48 for sites 20-40, respectively. The mobile devices may be any type of mobile device such as handheld computers, bar code scanners, laptop computers, beepers, mobile phones, personal digital assistants, WAN radios, etc. Examples of uses within a typical site 20, 30, 40 of mobile devices 26-28, 36-38, 46-48 include, but are not limited to, barcode scanning, price tagging, inventory management, communication, etc.

The mobile devices 26-28, 36-38 and 46-48 wirelessly communicate via wireless infrastructure devices (“WIDs”) 24, 34 and 44, respectively, to communicate with a wired infrastructure of the system 1. The connection between mobile devices 26, 36, 46 and WIDs 24, 34, 44 may be established, for example, over a wireless local area network (“WLAN”) using various wireless technologies, such as Bluetooth, IEEE 802.11b, or some other known wireless communication protocol. Examples of WIDs include access points, access ports, wireless switches, etc.

Each site 20, 30 and 40 also includes direct-connection protocol servers 22, 32 and 42 (“DCP server”), respectively. Examples of a DCP server 22, 32, 42 may include, for example, a file transfer protocol server (“FTP server”) or a trivial file transfer server (“TFTP server”). FTP and TFTP servers use standard Internet protocols to transfer files between computers. More specifically, a computer or mobile device may make a request for connection to a FTP or TFTP server to which the server responds by accepting or rejecting the request. Once the request is accepted, a connection is made (e.g., locally or via the Internet) between the requesting device and the accepting server. The FTP/TFTP protocols may then be used to send, receive, store and access files of any size from any internet connected devices, such as a plurality of mobile devices to a computer and/or database server. The DCP servers 22, 32, 42 are utilized primarily for provisioning mobile devices 26-28, 36-38, 46-48. Typically, they stage the configuration and firmware images that the mobile devices 26-28, 36-38, 46-48 may download.

Thus, in the example of FIG. 1, each site 20, 30 and 40 includes a DCP server, a WID and mobile devices. As described above, a site is a logical grouping and may include the DCP server and the mobile devices configured to communicate with the DCP server. Thus, an “assigned site” for a mobile device is the site to which the mobile device is configured to be in operation. For example, the assigned site of mobile device 26 is site 20. A “current site” is a site where the mobile device is currently located. Thus, in the example of FIG. 1, the current site of mobile device 26 is also site 20. However, if the mobile device 26 were moved from its current location to a location within site 30, the current site would then be site 30, but the assigned site would remain site 20.

The exemplary embodiment of system 1 further includes an enterprise management system (“EMS”) 10. The EMS 10 may be, for example, a centralized console that includes a mobile device management software platform. An example of such a software platform is the Symbol Technologies' Mobility Services Platform (“MSP”) that includes the capability of automatically managing mobile devices 26-28, 36-38 and 46-48 within a location and/or over a network. The MSP may serve as an interface for the EMS 10 to collect and maintain a record for each of the mobile devices 26-28, 36-38 and 46-48 within a particular site 20, 30 and 40. The MSP has a concept of sites and the association between DCP servers 22, 32, 42 and sites 20, 30, 40 to which they are associated (i.e., sites to which DCP server addresses correspond) is known and maintained by the MSP.

In the above described configuration, the EMS 10 may include the site information for each of the mobile devices 26-28, 36-38 and 46-48 in the system 1. Those interested in a complete description of how the mobile devices 26-28, 36-38 and 46-48 may interact with the EMS 10 to update the site location are referred to U.S. patent application Ser. No. 11/215,493 filed Aug. 29, 2005 and entitled “System and Method for Locating Mobile Devices Through a Direct Connection Protocol.”

However, the present invention is not limited to networks that include direct connection protocol servers for locating mobile devices or any of the methods described for locating the mobile devices in the above-identified patent application. Those of skill in the art will understand that there may be many manners for a mobile device to identify a site where the mobile device is located. The exemplary embodiments of the present invention are directed at locating devices (either mobile units or infrastructure devices) that are not capable of identifying their location directly to the EMS 10 (or other network entity).

The EMS 10 may periodically collect monitoring and status information from the mobile devices 26-28, 36-38 and 46-48 and the infrastructure devices (e.g., WIDs 24, 34 and 44). The mobile devices 26-28, 36-38 and 46-48 may include an EMS agent that is responsible for interfacing the mobile devices 26-28, 36-38 and 46-48 to the EMS 10. The EMS agent may collect various types of data from each mobile device such as management data, configuration data, performance data, etc., (e.g., model number, software version numbers, battery level, network throughput values, etc.) and forward this information to the EMS 10. The EMS 10 may collect this information and store this information for each of the devices for which it is receiving information. For example, the EMS 10 may include a database having a record for each device in the system 1. As the device information is received, the database may be updated to reflect the current state of the device. The EMS 10 may use this information to monitor and manage the system 1.

Part of this information for the mobile units 26-28, 36-38 and 46-48 may be an identification of the infrastructure device the mobile unit is using to access the network. For example, if mobile device 26 is using WID 24 to access the network, the EMS agent on the mobile device 26 may send the Extended Service Set Identifier (“ESSID”) to the EMS 10. Thus, the database record in the EMS 10 for the mobile device 26 may include the ESSID of the WID 24.

The infrastructure device through which a mobile device is connected may be considered to be the “parent” device for the mobile device. While all of the mobile devices that are connected via the infrastructure device may be considered to be “child” devices of the parent infrastructure device. Each of the child devices under a particular parent device may be considered to be “sibling” devices. In the exemplary system 1, it may be considered that mobile devices 26-28 have connected to the system 1 via the WID 24. Thus, the WID 24 would be considered the parent device for each of the mobile devices 26-28, each of the mobile devices 26-28 would be considered to be child devices of the WID 24 and each of the mobile devices 26-28 would be considered to be a sibling device to each of the other mobile devices 26-28.

In addition, the EMS 10 may also collect information from the WIDs 24, 34 and 44 such as the ESSID of the WID and the mobile device table in the WID. The mobile device table is a list of mobile devices that have used the WID to connect to the wired network. Thus, continuing with the example started above, the mobile device table for the WID 24 would include entries for the mobile devices 26-28. The mobile device table may include both active and inactive mobile devices. An “active” mobile device is one that is currently using the WID to access the network. An “inactive” mobile device is one that the WID is aware of, but it is not currently using the WID to connect to the network. Similar to the above description, this information collected from the WID may also be stored by the EMS 10. In the above description it was stated that the parent-child-sibling relationship may be determined based on the information provided to the EMS 10 by the EMS agents on the mobile devices. However, these relationships may also be determined using the mobile device table of the WID that is retrieved by the EMS 10.

The storage of data at the EMS 10 has been described as database storage. However, those of skill in the art will understand that there are numerous manners of storing information and that any of these manners are compatible with the present invention.

As part of the data that the EMS 10 may store for the individual mobile devices, the EMS 10 may store a device state or values associated with a particular state. The following are exemplary device states:

TABLE 1

| State | Description | Site Values |
|---|---|---|
| S1 | Mobile Device is not in the database | |
| S2 | Both site names are Unknown | Assigned = Unknown |
| | | Current = Unknown |
| S3 | Both site names are same and not | Assigned = X |
| | Unknown | Current = X |
| S4 | Mobile Device is not in its assigned site | Assigned = X |
| | | Current = Y |

Table 1 includes four states (S1-S4), a description of each state and the site values that correspond to each of the states. Thus, the EMS 10 may not specifically store the values S1-S4 for each mobile device, but rather may store a value for the Assigned Site and Current Site as those terms were defined above.

The state S1 is a state where the particular mobile device is not in the database. For example, before a new mobile device is deployed on the network, the EMS 10 may not have any information about the mobile device. The EMS 10 may not learn about the new mobile device until it connects to the network through a WID. Thus, when a mobile device is in state S1 there is no record of the device at the EMS 10.

The state S2 corresponds to the situation where the EMS 10 is aware of the mobile device and has a corresponding record for the device. However, the EMS 10 is neither aware of the site where the mobile device is assigned (e.g., Assigned Site=Unknown) nor aware of the current site of the mobile device (e.g., Current Site=Unknown). In this situation, the EMS 10 does not know whether the mobile device is in the correct location.

The state S3 corresponds to the situation where the EMS 10 is aware of both the assigned site and the current site of the mobile device and these sites are the same (e.g., Assigned Site=X and Current Site=X). In this situation, the mobile device is in the correct location and the EMS 10 can provide this information to the owner/operator of the network.

The state S4 corresponds to the situation where the EMS 10 is aware of both the assigned site and the current site of the mobile device, but these sites are not the same (e.g., Assigned Site=X and Current Site=Y). In this situation, the mobile device is not in the correct location and the EMS 10 can provide this information to the owner/operator of the network.

As will be described in greater detail below, the situation where just one of the site names (Assigned or Current) is known will not occur according to the exemplary rules that will be applied for propagating site names to the mobile units. Thus, this state need not be considered here. However, it is possible to amend the exemplary rules to include such a state or states and still be within the spirit and scope of the present invention. It should be apparent to those of skill in the art what these modifications to the rules described below would be to account for such states.

According to the exemplary embodiments of the present invention, the EMS 10 may use the state information that it includes for one or more mobile units to propagate state information to other mobile units and/or infrastructure devices. The following will provide several exemplary triggers that may initiate the mobile device site name propagation procedure to be carried out by the EMS 10. Those of skill in the art will understand that there may be more triggers and these are only exemplary. The exemplary triggers are:

TABLE 2

| Trigger | Description |
|---|---|
| T1 | Mobile Device registers without a site name |
| T2 | Mobile Device registers with a site name equal to the Assigned |
| | site name of the device |
| T3 | Mobile Device registers with a site name equal to the Current |
| | site name of the device |
| T4 | Mobile Device registers with a site name that is neither equal to |
| | Assigned site name nor Current site name |
| T5 | User updates the device (mobile or infrastructure) site |
| | name explicitly |

When a triggering event occurs, the EMS 10 may update site names for devices based on the following exemplary rules shown in Table 3:

TABLE 3

| Rule | Description |
|---|---|
| R1 | Propagate a device's current site name to other devices only in the |
| | following cases: |
| | Device discovered for the first time with a valid known site name |
| | Updated that device's Current site name from ‘Unknown’ to some |
| | known valid name. |
| R2 | When propagating a device's site name to another device, never |
| | overwrite the target device's site name. That is, only if the target |
| | device's site names were ‘Unknown’, would its site names |
| | be updated. |
| R3 | When a device's site name is updated from ‘Unknown’ to a known |
| | value, update both Assigned and Current site names to the same |
| | value. This means that for any device, never leave one site name |
| | as ‘Unknown’ and the other site name with a good known name. |
| R4 | Generate events that are related to device movements only when |
| | the device moves between two known sites; i.e., the device is not |
| | moving from Unknown site to a known site or vice versa. |

Thus, using the triggers and the rules defined above, the EMS 10 may propagate site information to various mobile units and/or infrastructure devices within the network. This will allow the owner/operator of the network to be made aware of when devices are not in their proper location.

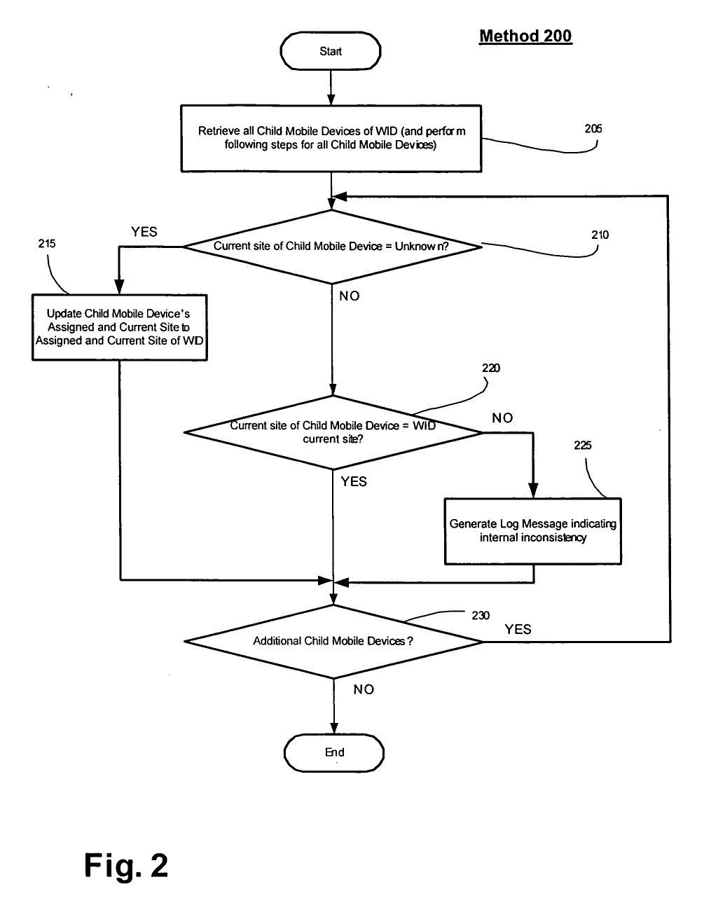

FIG. 2 provides an exemplary method 200 for the propagation of WID site names to its child mobile devices. The exemplary method also provides an example of the type of information that may be generated for the owner/operator when there is an inconsistency between the assigned site and the current site for a mobile device. The exemplary method 200 will be described with reference to the system 1 of FIG. 1. In this example, it is considered that for the exemplary WID, the site names (Assigned and Current) for the WID have already been updated. An exemplary method of updating the WID site information will be provided below.

In step 205, the EMS 10 will retrieve the records for all the child devices of the WID having the known location. For example, it may be considered that WID 24 has a known location of X, e.g., Assigned Site=X and Current Site=X. Because each of mobile devices 26-28 has connected to the network (active or inactive), the EMS 10 may include information that indicates that the mobile devices 26-28 are child devices of WID 24.

The following steps are carried out for each of the mobile devices that are children of the infrastructure device, e.g., mobile devices 26-28. In step 210, it is determined whether the current site of the mobile device is known. Thus, if the first mobile device to be checked is mobile device 26, the EMS 10 will check the record corresponding to mobile device 26 and determine the value for the current site parameter.

If the current site parameter value is not known, e.g., Current Site=Unknown, the method continues to step 215 where the mobile device's assigned and current site parameter value is set to the same value as the WIDS. For example, the current and assigned site values for the mobile device 26 may be set equal to X, i.e., the same value as the WID 24 that is the parent of the mobile device 26. Thus, in this case, the site information for the parent WID is propagated to the child mobile device. The method 200 then proceeds to step 230 (described below).

However, if in step 210, the current site of the mobile device is known, the method continues to step 220, where it is determined if the current site name of the mobile device is the same as the current site name of the WID. Again, using the example started above, the EMS 10 will compare the current site entry in the record corresponding to mobile device 26 to the current site name (X) of the WID 24. If the current site names of the WID and the mobile device match, then the mobile device is in the correct location and the method 200 proceeds to step 230 (described below).

However, if the current site name of the mobile device does not match the current site name of the WID, it indicates that the mobile device is not in the correct location. Thus, the method proceeds to step 225 where a log message is generated indicating the inconsistency. Thus, the owner/operator of the system 1 will be made aware of the inconsistency. Those of skill in the art will understand that the log message may take on many forms and any of these forms may be used with the exemplary embodiment of the present invention.

At the completion of any of steps 215, 220 or 225, the method continues to step 230 where it is determined if there are additional child mobile devices that need to be addressed. If there are additional child mobile devices (e.g., mobile devices 27 and 28), the process continues back to step 210 for the next mobile device. If there are no further child mobile devices, the method 200 is complete. A review of the exemplary method 200 will show that the steps of the method are consistent with the rules elaborated in Table 3.

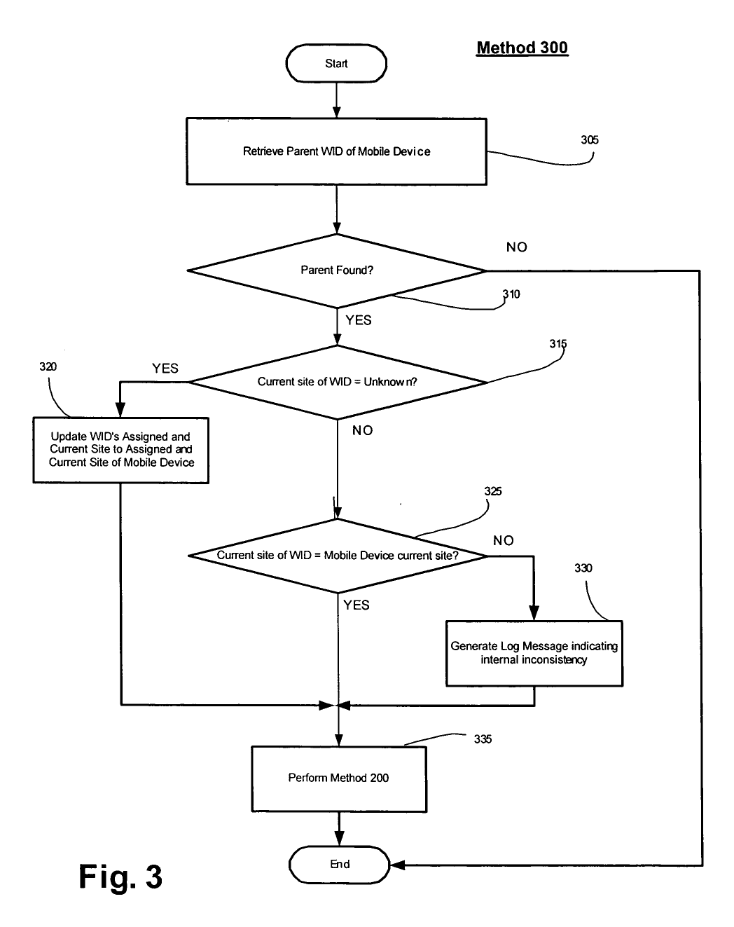

FIG. 3 provides an exemplary method 300 for the propagation of mobile device site names to its parent infrastructure device and other sibling mobile devices. The exemplary method 300 will be described with reference to the system 1 of FIG. 1. In this example, it is considered that for the exemplary mobile device, the site names (Assigned and Current) for the mobile device have already been updated. As described above, the update may have been based on a propagation of sites according to the exemplary embodiments of the present invention, based on other locating schemes, based on a manual update by a user/system administrator, etc. For example, if mobile device 36 had a user updated site name of Y (trigger T5 of Table 3), the method 300 would be executed.

Thus, in step 305, the EMS 10 will retrieve the parent WID device for the mobile device with the known address. In step 310, it is determined whether the EMS 10 includes a parent device for the mobile device. As stated above, in the case where mobile device 36 connected to the network via the WID 34, the EMS 10 may include information indicating that the WID 34 is the parent device of the mobile device 36. However, the EMS 10 may not always include this information. If the parent WID device is not known the method 300 is complete.

If the parent WID is found in step 310, it is determined if the current site information for the WID is known (step 315). Thus, continuing with the example, the EMS 10 will determine the current site value for the WID 34. If the current site value is not known (i.e., current site=Unknown), the method continues to step 320 where both the assigned and current site of the WID is updated to that of the mobile device. Thus, in this example, the assigned and current site values for WID 34 are updated to Y to correspond to the site values for the mobile device 36. The method 300 then continues to step 340 (described below).

If, in step 315, the current site of the WID is known, the method continues to step 325 to determine if the current site of the WID matches the current site of the mobile device. Thus, in step 325 it is determined if the current site of the WID 34 is the same as the current site Y for the mobile device 36. If the two sites match in step 325, the method 300 continues to step 340 (described below).

If the two sites do not match in step 325, the method continues to step 330 where a log message is generated indicating the inconsistency. For example, if the current site of the mobile device 36 is Y, while the current site of the WID 34 is X, a log message will be generated. Thus, the owner/operator of the system 1 will be made aware of the inconsistency.

At the completion of any of steps 320, 325 or 330, the method 300 continues to step 335 where the EMS may invoke the method 200 described above to propagate the updated WID information to the other child mobile devices of the WID, which would also be the sibling devices of the mobile device. Continuing with the example started above, the method 200 would then be executed for the child mobile devices 37 and 38 of WID 34. These mobile devices 37 and 38 are also sibling devices of the original mobile device 36 that triggered the execution of exemplary method 300. Again, a review of the exemplary method 300 will show that the steps of the method are consistent with the rules elaborated in Table 3.

The above two exemplary methods provided examples of how the exemplary embodiments of the present invention can propagate site information between different devices (mobile devices and infrastructure devices) on a network to provide the owner/operator with information concerning the location of devices within the network.

The following table summarizes the actions that may be taken for each trigger on each state. Thus, the current state shows the current state of the mobile device, the triggers shows the reason why a propagation may occur, the actions that will take place as a result of the trigger, the new state of the devices after the actions occur and any notes, where R=rules as listed in Table 3.

TABLE 4

| | Current | | | | |
|---|---|---|---|---|---|
| | State | Trigger | Action(s) | New State | Notes |
| 1. | S1 [Mobile | T1 [Mobile Device | Create the device | S2 if WID's | Propagation |
| | Device is not | registers without a | with both sites as | site can't be | because of R1 |
| | in the | site name] | Unknown | propagated | |
| | database] | | Retrieve Mobile | Otherwise S3 | |
| | | | Device's parent | | |
| | | | WID | | |
| | | | Execute method | | |
| | | | 200. [propagate | | |
| | | | WID's site name | | |
| | | | to child Mobile | | |
| | | | Devices] | | |
| 2. | S1 [Mobile | T4 [Mobile Device | Create the device | S3 | Propagation |
| | Device is not | registers with a site | with both sites | [Assigned = X | because of R1 |
| | in the | name X that is | equal to X. | Current = X] | |
| | database] | neither equal to | Execute method | | |
| | | assigned site nor | 300 [propagate | | |
| | | current site] | Mobile Device's | | |
| | | | site name to WID | | |
| | | | and sibling | | |
| | | | Mobile Devices] | | |
| 3. | S2 [Both | T1 [Mobile Device | Retrieve Mobile | S2 if WID's | Propagation |
| | sites are | registers without a | Device parent | site can't be | because of R1 |
| | Unknown] | site name] | WID | propagated | |
| | | | Execute method | Otherwise S3 | |
| | | | 200 | | |
| 4. | S2 [Both | T4 [Mobile Device | Update the | S3 | Propagation |
| | sites are | registers with a site | device with both | [Assigned = X | because of R1 |
| | Unknown] | name X that is | sites equal to X. | Current = X] | |
| | | neither equal to | Execute method | | |
| | | assigned site nor | 300 | | |
| | | current site] | | | |
| 5. | S2 [Both | T5 [User updates | Update the | S3 | Propagation |
| | sites are | the device with a | assigned and | [Assigned = X | because of R1 |
| | Unknown] | site name X] | current site | Current = X] | |
| | [Assigned = | | names of device | | |
| | Unknown | | to X | | |
| | Current = | | If Mobile Device | | |
| | Unknown] | | Execute | | |
| | | | Method 300 | | |
| | | | else Execute | | |
| | | | Method 200 | | |
| 6. | S3 [Both | T1 [Device | Leave both the | S3 | No |
| | sites same | registers without a | site names of the | [Assigned = X | propagation |
| | and not | site name] | device as they are | Current = X] | as per R1 |
| | Unknown] | | | | |
| | [Assigned = X | | | | |
| | Current = X] | | | | |
| 7. | S3 [Both | T2 [Device | Leave both the | S3 | No |
| | sites same | registers with a site | site names of the | [Assigned = X | propagation |
| | and not | name equal to the | device as they are | Current = X] | as per R1 |
| | Unknown] | assigned site (X)] | | | |
| | [Assigned = X | T3 [Device | | | |
| | Current = X] | registers with a site | | | |
| | | name equal to the | | | |
| | | current site (X)] | | | |
| 8. | S3 [Both | T4 [Device | Update Mobile | S4 | No |
| | sites same | registers with a site | Device's current | [Assigned = X | propagation |
| | and not | name Z that is | site to Z; | Current = Z] | as per R1 |
| | Unknown] | neither equal to | Generate event | | |
| | [Assigned = X | assigned site nor | E1 | | |
| | Current = X] | current site] | | | |
| 9. | S3 [Both | T5 [User updates | Update the | S3 | No |
| | sites same | the device with a | assigned and | [Assigned = Z | propagation |
| | and not | site name Z] | current site | Current = Z] | as per R1 |
| | Unknown] | | names of device | | No validation |
| | [Assigned = X | | to Z | | for Z. |
| | Current = X] | | | | Generally Z is |
| | | | | | not = X |
| 10. | S4 [Device is | T1 [Device | Leave both the | S4 | No |
| | not in its | registers without a | site names of the | [Assigned = X | propagation |
| | asssigned site] | site name] | device as they are | Current = Y] | as per R1 |
| | [Assigned = X | | | | |
| | Current = Y] | | | | |
| 11. | S4 [Device is | T2 [Device | Update Mobile | S3 | No |
| | not in its | registers with a site | Device's current | [Assigned = X | propagation |
| | assigned site] | name equal to the | site to X; | Current = X] | as per R1 |
| | [Assigned = X | assigned site (X)] | Generate event | | |
| | Current = Y] | | E2 | | |
| 12. | S4 [Device is | T3 [Device | Leave both the | S4 | No |
| | not in its | registers with a site | site names of the | [Assigned = X | propagation |
| | assigned site] | name equal to the | device as they are | Current = Y] | as per R1 |
| | [Assigned = X | current site (Y)] | | | |
| | Current = Y] | | | | |
| 13. | S4 [Device is | T4 [Device | Update Mobile | S4 | No |
| | not in its | registers with a site | Device's current | [Assigned = X | propagation |
| | assigned site] | name Z that is | site to Z; | Current = Z] | as per R1 |
| | [Assigned= X | neither equal to | Generate event | | |
| | Current = Y] | assigned site nor | E1 | | |
| | | current site] | | | |
| 14. | S4 [Device is | T5 [User updates | Update the | S3 | No |
| | not in its | the device with a | assigned and | [Assigned = Z | propagation |
| | assigned site] | site name Z] | current site | Current = Z] | as per R1 |
| | [Assigned = X | | names of device | | No validation |
| | Current = Y] | | to Z | | for Z. It could |
| | | | | | be equal to X |
| | | | | | or Y or some |
| | | | | | other value. |

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

1. A method, comprising:
receiving location information for one of a wireless infrastructure device (“WID”) and a mobile device, wherein the WID is a parent of the mobile device and the mobile device is a child of the WID;
retrieving data corresponding to the other one of the WID and the mobile device; and
updating the data, when the data does not include a known location information for the other one of the WID and the mobile device, to include the location information for the one of the WID and the mobile device.

2. The method of claim 1, further comprising:
comparing, when the data includes the known location information, the known location to the location information; and
generating an error message when the known location is different from the location information.

3. The method of claim 1, wherein, when WID is the one of the WID and the mobile device, repeating the retrieving and updating steps for all child mobile devices of the WID.

4. The method of claim 1, wherein the location information includes a current location and an assigned location.

5. The method of claim 1, wherein the known location includes a current location and an assigned location.

6. A method, comprising:
storing information corresponding to an assigned site and a current site for a plurality of devices, wherein unknown is valid information for the assigned site and the current site;
receiving a triggering event for one of the devices; and
propagating the assigned site and the current site for the one of the devices to at least one of the other devices.

7. The method of claim 6, wherein the devices include one of a mobile device and a wireless infrastructure device (“WID”).

8. The method of claim 6, wherein the triggering event is the one of the devices registering without a site name.

9. The method of claim 6, wherein the triggering event is the one of the devices registering with a site name equal to the assigned site.

10. The method of claim 6, wherein the triggering event is the one of the devices registering with a site name equal to the current site.

11. The method of claim 6, wherein the triggering event is the one of the devices registering with a site name not equal to the current site and the assigned site.

12. The method of claim 6, wherein the triggering event is a user of the one of the devices updating a site name.

13. The method of claim 6, wherein the at least one of the other devices assigned site and current site are unknown prior to the propagating step.

14. A network management device, comprising:
storage means for storing information corresponding to an assigned site and a current site for a plurality of devices, wherein unknown is valid information for the assigned site and the current site;
receiving means for receiving a triggering event for one of the devices; and
processing means for propagating the assigned site and the current site for the one of the devices to at least one of the other devices.

15. The network management device of claim 14, wherein the devices include one of a mobile device and a wireless infrastructure device (“WID”).

16. The network management device of claim 14, wherein the triggering event is the one of the devices registering without a site name.

17. The network management device of claim 14, wherein the triggering event is the one of the devices registering with a site name equal to the assigned site.

18. The network management device of claim 14, wherein the triggering event is the one of the devices registering with a site name equal to the current site.

19. The network management device of claim 14, wherein the triggering event is the one of the devices registering with a site name not equal to the current site and the assigned site.

20. The network management device of claim 14, wherein the triggering event is a user of the one of the devices updating a site name.
